(19) United States
(12) Patent Application Publication
(10) Pub. No.: US 2023/0066744 A1
(43) Pub. Date: Mar. 2, 2023

(54) Battery Powered Microwave Apparatus

(71) Applicants: Peter Faualo, Honolulu, HI (US); Ashley Tiqui-Faualo, Honolulu, HI (US)

(72) Inventors: Peter Faualo, Honolulu, HI (US); Ashley Tiqui-Faualo, Honolulu, HI (US)

(21) Appl. No.: 17/412,366

(22) Filed: Aug. 26, 2021

(51) Int. Cl. H05B 6/64; H05B 6/66; H05B 6/80

(52) U.S. Cl. CPC H05B 6/6402; H05B 6/6426; H05B 6/664; H05B 6/6435; H05B 6/80

(57) ABSTRACT

A battery powered microwave apparatus for microwaving food items without a power supply includes a housing. A housing front side has a door aperture extending through to a housing cavity. A door is pivotably coupled to the housing front side to selectively cover or uncover the door aperture. A microwave is coupled within the housing. A plurality of controls is coupled to the housing front side and is in operational communication with the microwave. A power supply is coupled within the housing and is in operational communication with the microwave. A battery bank includes a plurality of contacts and a plurality of battery supports configured to selectively receive a plurality of portable tool batteries to power the apparatus.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to microwave oven device and more particularly pertains to a new microwave oven devices for microwaving food items without a power supply. This device includes a plurality of battery holders to selectively receive portable tool batteries. The device may also plug in to a standard power outlet.

### (2) Description of Related Art Including Information Disclosed Under 37 CFR 1.97 and 1.98

The prior art relates to microwave oven devices. Known devices typically require a plug-in power source, even when robustly designed for jobsite use. These devices are not able to receive and draw power from standard portable tool batteries. Known devices also lack strap connection loops for easy carrying on the user's shoulder with a strap.

### BRIEF SUMMARY OF THE INVENTION

An embodiment of the disclosure meets the needs presented above by generally comprising a housing having a housing front side, a housing back side, a housing left side, a housing right side, a housing top side, and a housing bottom side defining a housing cavity. The housing front side has a door aperture extending through to the housing cavity. A door is coupled to the housing. The door is pivotably coupled to the housing front side to selectively cover or uncover the door aperture. A microwave is coupled within the housing. A plurality of controls is coupled to the housing. The plurality of controls is coupled to the housing front side and is in operational communication with the microwave. A door button is coupled to the housing. The door button is coupled to the housing front side and is in operational communication with the door. A power supply is coupled within the housing and is in operational communication with the microwave. A power cord is coupled to the housing and is in operational communication with the power supply. A battery bank is coupled to the housing. The battery bank includes a plurality of contacts and a plurality of battery supports configured to selectively receive a plurality of portable tool batteries. The plurality of contacts is in operational communication with the power supply.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a battery powered microwave apparatus according to an embodiment of the disclosure.

FIG. 2 is a front elevation view of an embodiment of the disclosure.

FIG. 3 is a side elevation view of an embodiment of the disclosure.

FIG. 4 is a rear elevation view of an embodiment of the disclosure.

FIG. 5 is an in-use view of an embodiment of the disclosure.

### DETAILED DESCRIPTION OF THE INVENTION

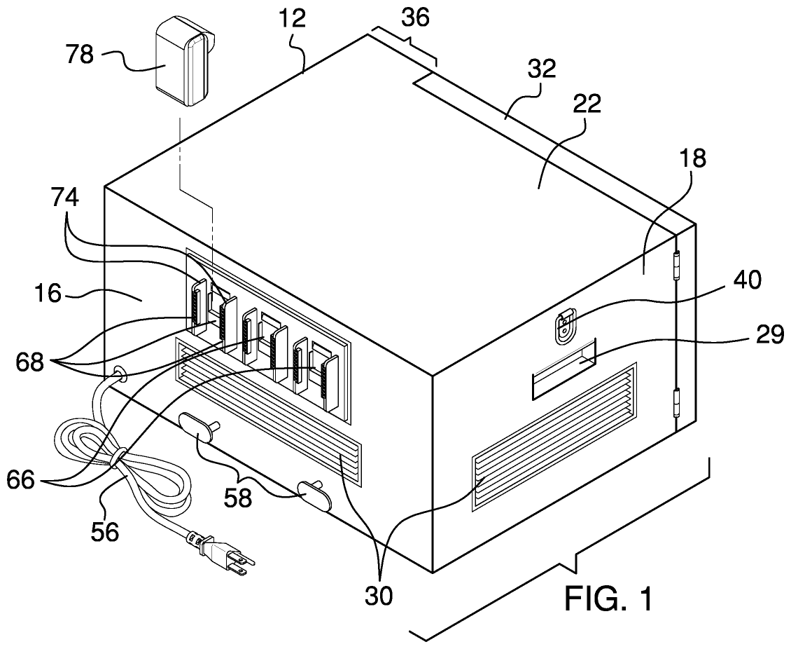

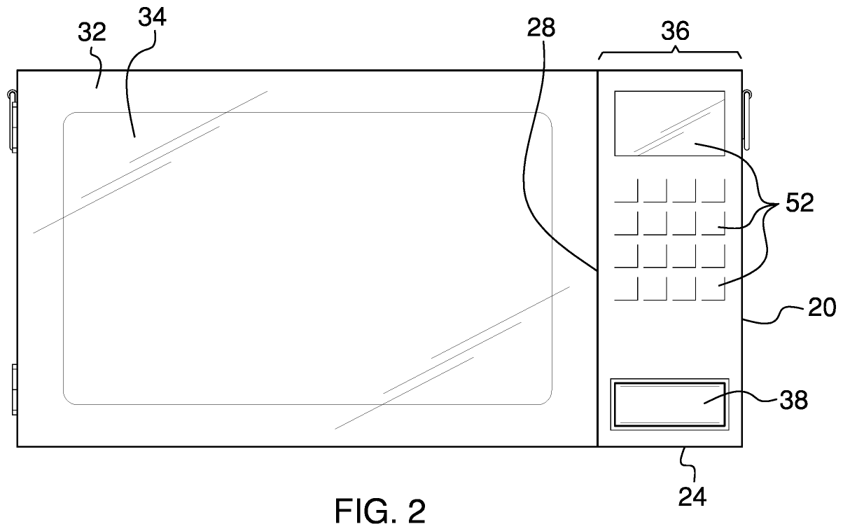

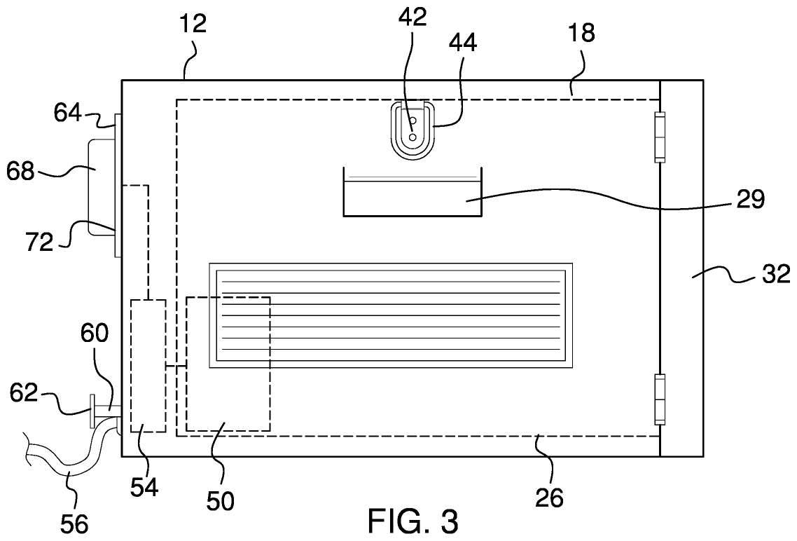

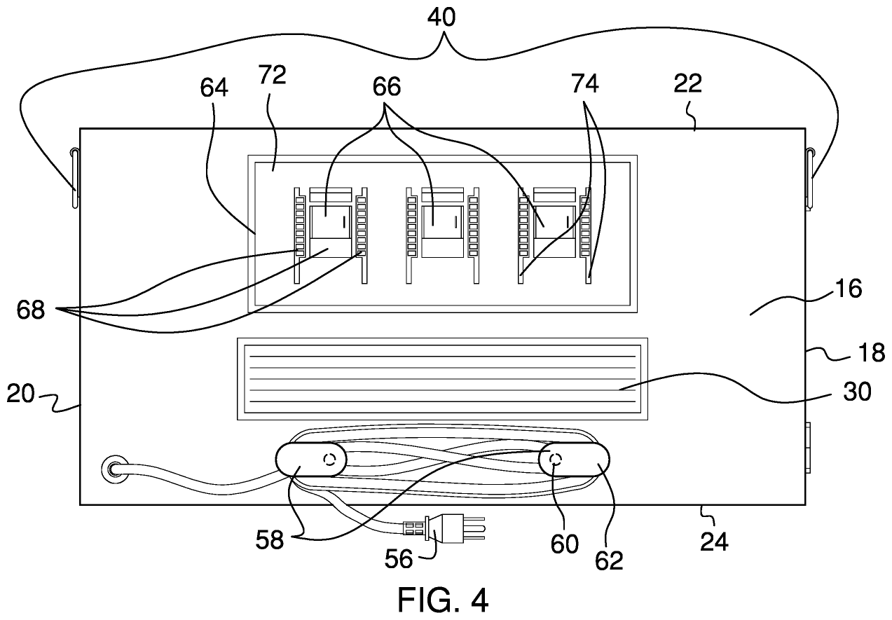

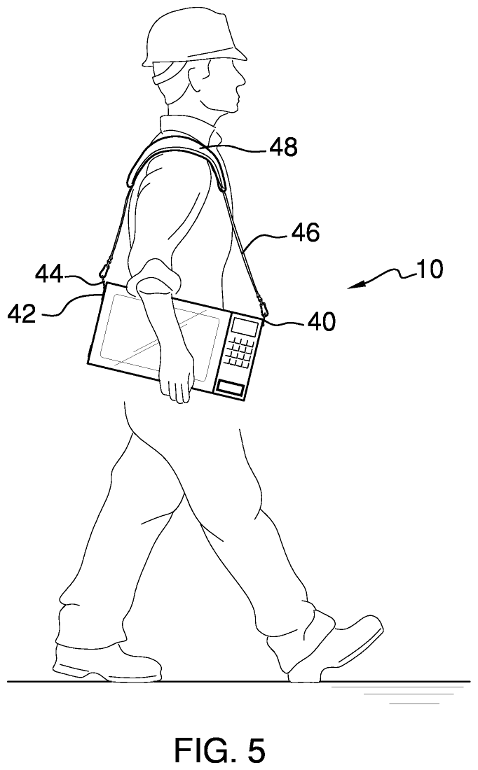

With reference now to the drawings, and in particular to FIGS. 1 through 5 thereof, a new microwave oven device embodying the principles and concepts of an embodiment of the disclosure and generally designated by the reference numeral 10 will be described.

As best illustrated in FIGS. 1 through 5, the battery powered microwave apparatus 10 generally comprises a housing 12 having a housing front side 14, a housing back side 16, a housing left side 18, a housing right side 20, a housing top side 22, and a housing bottom side 24 defining a housing cavity 26. The housing front side 14 has a door aperture 28 extending through to the housing cavity 26. Each of the housing left side 18 and the housing right side 20 may have an integrated handle cavity 29. The housing 12 may have a pair of louvered vents 30 extending through the housing left side 18 and the housing back side 16 to prevent overheating.

A door 32 is coupled to the housing 12. The door 32 is pivotably coupled to the housing front side 14 to selectively cover or uncover the door aperture 28. The door 32 may have a transparent window portion 34 to allow the user to see progress of the item being cooked within the housing cavity 26. The housing front side 14 may have a protrusion portion 36 adjacent the housing right side 20 and the door aperture 28 to be flush with the door 32. A door button 38 is coupled to the housing 12. The door button 38 is coupled to the protrusion portion 36 of the housing front side and is in operational communication with the door 32 to uncover the door aperture 28 as desired.

A pair of strap rings 40 is coupled to the housing left side 18 and the housing right side 20 proximal the housing top side 22. The pair of strap rings may include a fixed portion 42 coupled to the housing 12 and a D-ring 44 pivotably coupled to the fixed portion 42. Each D-ring 44 may selectively receive a shoulder strap 46. The shoulder strap 46 may have a padded medial portion 48 for user comfort.

A microwave 50 is coupled within the housing 12. A plurality of controls 52 is coupled to the housing 12. The plurality of controls 52 is coupled to the protrusion portion 36 of the housing front side above the door button 38 and is in operational communication with the microwave 50. The plurality of controls 52 is used to operate the microwave 50 for custom or preset power settings and time durations.

A power supply 54 is coupled within the housing 12. The power supply 54 is in operational communication with the microwave 50. A power cord 56 is coupled to the housing 12 and is in operational communication with the power supply 54 when a power source is available. A pair of cord holders 58 is coupled to the housing back side 16. Each of the cord holders 58 has a cylindrical protrusion 60 and an obround stop 62 coupled to the protrusion 60. The pair of cord holders 58 windingly receives the power cord 56 when not in use.

A battery bank 64 is coupled to the housing 12. The battery bank 64 includes a plurality of contacts 66 and a plurality of battery supports 68 configured to selectively receive a plurality of portable tool batteries 70. The battery bank 64 may have a rectangular bank wall 72 extending from the housing back side 16. The plurality of battery supports 68 extends from the bank wall 72. The plurality of contacts 66 is in operational communication with the power supply 54 to operate the microwave 50 using the plurality of portable tool batteries 70. The plurality of contacts 66 may be arranged horizontally with the plurality of battery supports 68 including a pair of vertical side supports 74 surrounding each of the contacts 66.

In use, the apparatus 10 is carried to a jobsite using either the integrated handle cavities 28 or the shoulder strap 46. The plurality of portable tool batteries 70 are engaged within the battery bank 64 to power the microwave 50. The user may then manipulate the plurality of controls 52 to cook food items as desired without a nearby power source.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A battery powered microwave apparatus comprising:
a housing having a housing front side, a housing back side, a housing left side, a housing right side, a housing top side, and a housing bottom side defining a housing cavity, the housing front side having a door aperture extending through to the housing cavity;
a door coupled to the housing, the door being pivotably coupled to the housing front side to selectively cover or uncover the door aperture;
a microwave coupled within the housing;
a plurality of controls coupled to the housing, the plurality of controls being coupled to the housing front side and being in operational communication with the microwave;
a door button coupled to the housing, the door button being coupled to the housing front side and in operational communication with the door.
a power supply coupled within the housing, the power supply being in operational communication with the microwave;
a power cord coupled to the housing, the power cord being in operational communication with the power supply; and
a battery bank coupled to the housing, the battery bank including a plurality of contacts and a plurality of battery supports configured to selectively receive a plurality of portable tool batteries, the plurality of contacts being in operational communication with the power supply.

2. The battery powered microwave apparatus of claim 1 further comprising each of the housing left side and the housing right side having an integrated handle cavity.

3. The battery powered microwave apparatus of claim 1 further comprising a pair of strap rings coupled to the housing left side and the housing right side proximal the housing top side, the pair of strap rings selectively receiving a shoulder strap.

4. The battery powered microwave apparatus of claim 1 further comprising the shoulder strap having a padded medial portion.

5. The battery powered microwave apparatus of claim 1 further comprising a pair of cord holders coupled to the housing back side, each of the cord holders having a cylindrical protrusion and an obround stop coupled to the protrusion, the pair of cord holders windingly receiving the power cord.

6. The battery powered microwave apparatus of claim 1 further comprising the housing having a pair of louvered vents extending through the housing left side and the housing back side.

7. The battery powered microwave apparatus of claim 1 further comprising the battery bank having a rectangular bank wall extending from the housing back side, the plurality of battery supports extending from the bank wall.

8. The battery powered microwave apparatus of claim 1 further comprising the door having a transparent window portion.

9. The battery powered microwave apparatus of claim 1 further comprising the plurality of contacts being arranged horizontally with the plurality of battery supports including a pair of vertical side supports surrounding each of the contacts.

10. A battery powered microwave apparatus comprising:
a housing having a housing front side, a housing back side, a housing left side, a housing right side, a housing top side, and a housing bottom side defining a housing cavity, the housing front side having a door aperture extending through to the housing cavity, each of the housing left side and the housing right side having an integrated handle cavity, the housing having a pair of louvered vents extending through the housing left side and the housing back side;
a door coupled to the housing, the door being pivotably coupled to the housing front side to selectively cover or uncover the door aperture, the door having a transparent window portion;
a pair of strap rings coupled to the housing left side and the housing right side proximal the housing top side, the pair of strap rings selectively receiving a shoulder strap, the shoulder strap having a padded medial portion;
a microwave coupled within the housing;
a plurality of controls coupled to the housing, the plurality of controls being coupled to the housing front side and being in operational communication with the microwave;
a door button coupled to the housing, the door button being coupled to the housing front side and in operational communication with the door.
a power supply coupled within the housing, the power supply being in operational communication with the microwave;
a power cord coupled to the housing, the power cord being in operational communication with the power supply;
a pair of cord holders coupled to the housing back side, each of the cord holders having a cylindrical protrusion and an obround stop coupled to the protrusion, the pair of cord holders windingly receiving the power cord; and
a battery bank coupled to the housing, the battery bank including a plurality of contacts and a plurality of battery supports configured to selectively receive a plurality of portable tool batteries, the battery bank having a rectangular bank wall extending from the housing back side, the plurality of battery supports extending from the bank wall, the plurality of contacts being in operational communication with the power supply, the plurality of contacts being arranged horizontally with the plurality of battery supports including a pair of vertical side supports surrounding each of the contacts.
